(19) United States
(12) Patent Application Publication
(10) Pub. No.: US 2024/0157927 A1
(43) Pub. Date: May 16, 2024

(54) METHOD FOR CHECKING FUNCTIONING OF A PRESSURE-MEDIUM OPERATED ELECTRONIC BRAKE SYSTEM OF A VEHICLE

(71) Applicant: ZF CV Systems Global GmbH, Bern (CH)

(72) Inventors: Christoph Brockmann, Hemmingen (DE); Tobias Munko, Hannover (DE); Joachim Pracht, Hannover (DE); Gerd Roters, Wunstorf (DE)

(21) Appl. No.: 18/412,286

(22) Filed: Jan. 12, 2024

Related U.S. Application Data
(63) Continuation of application No. PCT/EP2022/069656, filed on Jul. 13, 2022.

(30) Foreign Application Priority Data
Jul. 13, 2021 (DE) 10 2021 118 006.6

(51) Int. Cl. B60T 17/22; B60T 8/17; B60T 8/32; B60T 13/68

(52) U.S. Cl. CPC B60T 17/222; B60T 8/327; B60T 13/683; B60T 8/1708

(57) ABSTRACT

A method is for function checking of a pressure-medium operated electronic brake system of a vehicle, having a valve and sensor device, having a brake cylinder for actuating a brake, having an ABS solenoid control valve associated with the brake cylinder. For function checking of the control valve, it is temporarily activated and pressurized via the control unit and via the valve and sensor device such that pressure builds up at the input side of the control valve although a pressure increase in the associated brake cylinder is not expected, or a decrease after an interim increase is expected, and a malfunction of the anti-lock braking system solenoid control valve is identified if, contrary to expectations, a response of the vehicle due to a pressure increase in the brake cylinder, or due to the lack of a decrease after an increase, is established during this function check.

### CROSS-REFERENCE TO RELATED APPLICATIONS

This application is a continuation application of international patent application PCT/EP2022/069656, filed Jul. 13, 2022, designating the United States and claiming priority from German application 10 2021 118 006.6, filed Jul. 13, 2021, and the entire content of both applications is incorporated herein by reference.

### TECHNICAL FIELD

The disclosure relates to a method for function checking of a pressure-medium operated electronic brake system of a vehicle, having a valve and sensor device, referred to as an axle modulator, having at least one brake cylinder for actuating the brake of a vehicle wheel, having at least one anti-lock braking system solenoid control valve associated with the at least one brake cylinder, and having an electronic control unit, which is electrically connected to the valve and sensor device and to the at least one anti-lock braking system solenoid control valve, wherein the anti-lock braking system solenoid control valve has an inlet valve for aerating the brake cylinder and an outlet valve for venting the brake cylinder and is pneumatically connected to the valve and sensor device at the input side and to the brake cylinder at the output side.

The disclosure also relates to a method for function checking of a pressure-medium operated electronic brake system of a vehicle without an axle modulator, having at least one brake cylinder for actuating the brake of a vehicle wheel, having at least one anti-lock braking system solenoid control valve associated with the at least one brake cylinder, having a solenoid valve which conducts a current pneumatic brake pressure to the anti-lock braking system solenoid control valve in the non-actuated state and a pneumatic supply pressure to the anti-lock braking system solenoid control valve in the actuated state, having an electronic control unit, which is electrically connected to the at least one anti-lock braking system solenoid control valve, wherein the anti-lock braking system solenoid control valve has an inlet valve for aerating the brake cylinder and an outlet valve for venting the brake cylinder and is pneumatically connected to the solenoid valve at the input side and to the brake cylinder at the output side.

Moreover, the disclosure relates to an electronic control unit for carrying out such a method and an electronic brake system having a control unit of this type and a vehicle having such a brake system.

### BACKGROUND

Electronically controlled brake systems in vehicles, for example in utility vehicles, which are operated using a pneumatic pressure medium, are generally known. For example, printed document No. 815 020 015 3 by WABCO Europe BVBA, with the title “EBS für Motorwagen and Busse-Systembeschreibung” [EBS in Motor Vehicles and Buses-System Description], Version 4/12.2016, discloses a brake system of this type.

To activate the individual brake cylinders of heavy vehicles, such as trucks, buses or vehicle combinations, which are equipped with such a brake system, valve and sensor devices are used, which are also known as so-called axle modulators. These axle modulates serve to control the brake cylinder pressure on both sides of one or more vehicle axles depending on the current setpoint deceleration request of the vehicle. The value of this setpoint deceleration is specified, for example, by the driver of the vehicle actuating a brake value generator via a brake pedal or by an autonomous electronic control. The axle modulator ascertains the wheel speeds of the vehicle wheels from the wheel rotation speeds measured by rotation sensors, evaluates these wheel speeds and sends the result to a central electronic control unit. The central control unit controls and monitors the electronic brake system. It ascertains, for example, the setpoint deceleration of the vehicle from the above-mentioned signal of the brake value generator. The setpoint deceleration and the wheel speeds together form the input signal for the electropneumatic control. From this input signal, the control unit calculates setpoint pressure values for the brake cylinder of the front axle, setpoint pressure values for the brake cylinder of the rear axle and, where applicable, setpoint pressure valves for a trailer control valve. The setpoint pressure values are compared to currently measured actual pressure values in each case.

An anti-lock braking system (ABS™) of the vehicle is typically integrated in such an electronic brake system. In an anti-lock braking system, an anti-lock braking system solenoid control valve is generally associated with each brake cylinder of each vehicle axle which can be braked. These anti-lock braking system solenoid control valves are simply referred to as ABS solenoid control valves below. An ABS solenoid control valve of this type has an inlet valve and an outlet valve. In a normal driving state, the ABS solenoid control valves are opened and control the specified setpoint pressure which is output to the brake cylinders. In an ABS situation, that is, in the case of at least one vehicle wheel locking, the inlet valves close and initially do not permit a further pressure increase at the respective brake cylinder. If the wheels still continue to lock, pressure is released from the brake cylinders via the above-mentioned outlet valve in the ABS solenoid control valve. The anti-lock braking system integrated in the electronic brake system assumes control independently here, in that, for example, the specified setpoint pressure is modified if at least one of the wheels is tending to lock or spin.

In practice, brake systems of the type mentioned function reliably and have proven effective. However, there is still a need for improvement in terms of the safety integrity level of such systems. If, in the event of a malfunction of an ABS solenoid control valve, in particular in the case of a mechanical defect, the pneumatic pressure cannot be modulated by activating the inlet valve to stop the pressure increase in the brake cylinder or by activating the outlet valve to decrease the pressure in the brake cylinder, these control functions may no longer function correctly, if at all. The consequence of this may be an unexpected braking behavior on one side or on both sides of the vehicle, which, in the worst case, may also result in safety-critical situations.

The electronic control of the brake system may not promptly identify a faulty brake control of this type and trace it back to mechanical valve damage. Therefore, a faulty brake control of this type many also not be signaled to the driver in order to warn him in advance of an unexpected braking behavior of a wheel or the vehicle. An additional pressure sensor could optionally be used at each brake cylinder in order to permanently monitor the brake pressure at each brake cylinder. However, this would lead to higher production costs and require a complex electronic control and monitoring system.

A method for function checking of a pressure-medium operated electronic brake system of a vehicle is known from US 2020/0139953, in which a high safety integrity level of the brake system is achieved by carrying out function checking of a setpoint pressure sensor of the brake system and outputting a fault signal if a fault is identified. However, in the known method, mechanical defects in the solenoid control valves of the brake system are not identified.

It is an object of the disclosure to provide a method which increases the operational safety of a pressure-medium operated electronic brake system of a vehicle and which can be implemented in such a brake system in a cost-effective manner. In particular, defects in electric ABS solenoid control valves of a brake system of this type should be identified as promptly as possible. Moreover, such a method should be suitable for implementation in pneumatic brake systems of utility vehicles.

The disclosure therefore relates to a method for function checking of a pressure-medium operated electronic brake system of a vehicle, having a valve and sensor device, referred to as an axle modulator, having at least one brake cylinder for actuating the brake of a vehicle wheel, having at least one anti-lock braking system solenoid control valve associated with the at least one brake cylinder, and having an electronic control unit, which is electrically connected to the valve and sensor device and to the at least one anti-lock braking system solenoid control valve, wherein the anti-lock braking system solenoid control valve has an inlet valve for aerating the brake cylinder and an outlet valve for venting the brake cylinder and is pneumatically connected to the valve and sensor device at the input side and to the brake cylinder at the output side.

To achieve the object, this method of the disclosure provides that, for function checking, the anti-lock braking system solenoid control valve is temporarily activated and pressurized via the electronic control unit and via the valve and sensor device in such a way that a pressure is built up at the input side of the anti-lock braking system solenoid control valve although a pressure increase in the associated brake cylinder is not expected, or a pressure decrease after an interim pressure increase is expected, and a malfunction of the anti-lock braking system solenoid control valve is identified if, contrary to expectations, a response of the vehicle due to a pressure increase in the brake cylinder, or due to the lack of a pressure decrease after a pressure increase, is established during this function check.

An anti-lock braking system solenoid control valve is understood to refer to a valve unit consisting of multiple individual valves for controlling a pneumatic brake pressure in a brake cylinder, the anti-lock braking system solenoid control valve being associated with a vehicle wheel. In particular, such an anti-lock braking system solenoid control valve has an inlet valve for aerating, and an outlet valve for venting, a brake cylinder connected thereto. For simplification, the abbreviation ABS solenoid control valve is also used below. An individual anti-lock braking system solenoid control valve may also be associated with, and control the actuation of, multiple vehicle wheels or brake cylinders at each axle or at each side of the vehicle.

A valve and sensor device which is configured as an axle modulator has multiple electrically activatable solenoid control valves, such as input valves and output valves, relay valves and/or redundancy valves, and at least one pressure sensor. For simplification, a device of this type is therefore referred to as an axle modulator below.

Via various methods according to the disclosure, in particular mechanical malfunctions of the ABS solenoid control valves present in a brake system of a vehicle may be reliably identified. The method can advantageously be carried out both in brake systems of individual vehicles, such as trucks or buses, and in brake systems of vehicle combinations, for example in articulated trucks or in agricultural tractors and trailers.

Accordingly, in the first-mentioned brake system, which has an axle modulator, the pneumatic input of an ABS solenoid control valve to be function checked is acted upon by the pressure medium provided by the axle modulator and, at the same time, activated such that pressure is not built up at the output to the brake cylinder or an actuating pressure is initially built up in the brake cylinder and then immediately decreased again. If the ABS solenoid control valve is operating correctly, the relevant wheel is not braked when traveling or is held stationary when the vehicle moves off. On the other hand, if the ABS solenoid control valve is not working at all or is faulty, a pressure build-up in the brake cylinder takes place, or a pressure which is built up in the brake cylinder by way of experiment is not reduced again. This may be identified by the driver and/or detected and signaled by an existing system, which monitors the vehicle response or the response of the relevant vehicle wheel.

However, the disclosure can also be advantageously used for function checking of an ABS solenoid control valve in which the brake system does not have an axle modulator or such a valve and sensor device.

Accordingly, the disclosure relates to a method for function checking of a pressure-medium operated electronic brake system of a vehicle without an axle modulator, having at least one brake cylinder for actuating the brake of a vehicle wheel, having at least one anti-lock braking system solenoid control valve associated with the at least one brake cylinder, having a solenoid valve which conducts a current pneumatic brake pressure to the anti-lock braking system solenoid control valve in the non-actuated state and a pneumatic supply pressure to the anti-lock braking system solenoid control valve in the actuated state, having an electronic control unit, which is electrically connected to the at least one anti-lock braking system solenoid control valve, wherein the anti-lock braking system solenoid control valve has an inlet valve for aerating the brake cylinder and an outlet valve for venting the brake cylinder and is pneumatically connected to the solenoid valve at the input side and to the brake cylinder at the output side.

According to the disclosure, in this brake system without an axle modulator, it is provided that, for function checking of the anti-lock braking system solenoid control valve, this latter is temporarily activated and pressurized via the electronic control unit in such a way that a pressure is built up at the input side of the anti-lock braking system solenoid control valve although a pressure increase in the associated brake cylinder is not expected, or a pressure decrease after an interim pressure increase is expected, and a malfunction of the anti-lock braking system solenoid control valve is identified if, contrary to expectations, a response of the vehicle due to a pressure increase in the brake cylinder, or due to the lack of a pressure decrease after a pressure increase, is established during this function check.

According to an embodiment of the method according to the disclosure, regardless of whether or not the brake system has an axle modulator, it may be provided that automatic monitoring of a vehicle response due to a faulty brake pressure build-up in one or more brake cylinders takes place in that a braking torque and/or a yaw moment of the vehicle and/or a wheel slip of the vehicle wheel or the relevant vehicle wheels and/or a spontaneous driver response, such as a driving pedal actuation or a counter-steering movement by the driver, as a result of such a vehicle response is ascertained and evaluated. If a malfunction of the inlet valve or the outlet valve of the relevant anti-lock braking system solenoid control valve or the inlet valves or the outlet valves of the relevant anti-lock braking system solenoid control valves is identified in this way, a warning signal is generated and the driver is made aware.

Accordingly, there are various options available for promptly identifying an ABS solenoid control valve which is not operating correctly. It is therefore possible to dispense with costly pressure sensors on each brake cylinder. In particular, critical driving situations which might be caused by a defective ABS solenoid control valve may be reliably avoided.

According to a second embodiment of the method according to the disclosure, it may be provided that, to identify a defective inlet valve of the anti-lock braking system solenoid control valve in the non-braked state of the vehicle at a driving speed below a specified driving speed limit value, at least the following steps are carried out:
a) activating the inlet valve to set its closed position,
b) activating the inlet valve to set its closed position or maintain this closed position,
c) pressurizing the inlet valve and inferring a malfunction of the inlet valve if, following the last step, a response of the vehicle which correlates with the function checking of the inlet valve is established.

Accordingly, a defective inlet valve of an ABS solenoid control valve, for example at a brake cylinder in the region of a front wheel, may be identified via the electronic control device via the axle modulator in that, when traveling at a low speed, pressure is built up briefly at the relevant inlet valve and the inlet valve is, at the same time, activated to set its closed position for the duration of the pressurization. Since the brake cylinder is vented when traveling without braking, pressure cannot be built up in the brake cylinder during this time if, according to the activation, the input valve is closed by the electronic control unit. On the other hand, since the outlet valve is likewise closed, a pressure build-up in the brake cylinder would at least point to an input valve which is not closing correctly and which does not block the pressure applied at the input side of the input valve completely, if at all.

According to a third embodiment of the method according to the disclosure, it may be provided that, to identify a defective outlet valve of the anti-lock braking system solenoid control valve in the non-braked state of the vehicle when the vehicle is stationary, the following steps are carried out:
d) activating the inlet valve to set its aerating position or maintain this aerating position in order to build up a pressure in the brake cylinder,
e) activating the outlet valve to set its closed position or maintain this closed position,
f) pressurizing the inlet valve,
g) activating the inlet valve to set its closed position, and
h) activating the outlet valve to set its venting position in order to decrease the pressure which has built up in the brake cylinder completely, and inferring a malfunction of the outlet valve if, following the last step, a response of the vehicle which correlates with the function checking of the outlet valve is established.

Accordingly, a defective outlet valve of an ABS solenoid control valve, for example at a brake cylinder positioned on the axle of a front wheel, may be identified via the electronic control device in that the inlet valve is initially switched to its aerating position or this aerating position is maintained in order to build up a brake pressure in the brake cylinder. At the same time, the outlet valve is activated to set or maintain its closed position. The inlet valve is then acted upon by pressure and the inlet valve is then switched to its closed position and the brake cylinder is aerated by opening the outlet valve. If the outlet valve is intact, the brake cylinder should then be accordingly unpressurized during a subsequent moving-off procedure of the vehicle. However, if pressure remains in the brake cylinder, this would indicate that the outlet valve is not opening correctly. This might be identified, for example, based on the relevant vehicle wheel being held stationary due to the brake pressure during the subsequent moving-off procedure of the vehicle. Before checking the outlet valve, it is advantageously possible to test the associated input valve in order to ensure that the inlet valve is functioning correctly during the testing procedure for the outlet valve.

According to another embodiment of the method according to the disclosure, it may be provided that the activation of the outlet valve switches repeatedly back and forth between setting the venting position and setting the closed position. The dynamic behavior of the outlet valve may be detected by repeatedly switching the outlet valve on and off in quick succession. It is thus possible to identify if the valve responds to the activation with a time delay and/or incompletely or the outlet valve opens incompletely and/or closes incompletely.

It may furthermore be provided that the function checking of one or more anti-lock braking system solenoid control valves takes place after switching on the ignition of a drive motor of the vehicle in each case or after the vehicle moves off following the ignition of the drive motor in each case.

An electronic brake system generally has multiple ABS solenoid control valves, each having an inlet valve and an outlet valve. Each function check at an ABS solenoid control valve or at its inlet valve and/or at its outlet valve of a pneumatically operated brake system requires compressed air and causes switching noises. It is therefore advantageous to limit the frequency of the valve actuations. For example, it may be provided that the temporary test-related pressurization at the individual ABS solenoid control valves takes place only once after switching on the ignition of the drive motor, or after the vehicle moves off, in each case.

According to an alternative embodiment of the disclosure, it may be provided that the function checking of one or more anti-lock braking system solenoid control valves takes place once in a specified cycle of ignition procedures of the drive motor, or moving-off procedures of the vehicle following the ignition, in each case. This may already improve the safety integrity level of the brake system of the vehicle.

Moreover, it may be provided that the function checking of multiple anti-lock braking system solenoid control valves takes place at each axle. A vehicle axle with faulty braking may thus be quickly detected.

It is essentially possible for function checking of one or more anti-lock braking system solenoid control valves to take place at any time if it is suspected based on data of a sensor, for example a wheel rotation speed sensor or a brake pressure sensor, that an anti-lock braking system solenoid control valve is not functioning correctly.

The disclosure also relates to an electronic control unit of a pressure-medium operated electronic brake system of a vehicle, which is configured for function checking of anti-lock braking system solenoid control valves of the brake system and can be operated to carry out a method according to the disclosure.

To carry out the method having the features of the disclosure, an existing electronic control unit of an electronic brake system may be advantageously used, wherein a suitable expansion of the control software in a manner relevant to the method is needed in this control unit. Additional hardware components or other components are not required.

Moreover, the disclosure relates to a pressure-medium operated electronic brake system of a vehicle, which can be controlled by an electronic control unit for function checking of anti-lock braking system solenoid control valves of a brake system.

Finally, the disclosure also relates to a vehicle, such as a utility vehicle or a towing vehicle/trailer vehicle combination, having a pressure-medium operated electronic brake system, which is built according to the disclosure.

### BRIEF DESCRIPTION OF DRAWINGS

The invention will now be described with reference to the drawings wherein:

FIG. 1 shows a schematic partial view of a vehicle with a front axle and with a pressure-medium operated electronic brake system;

FIG. 2 shows a schematic, simplified view of an anti-lock braking system solenoid control valve of a brake system according to FIG. 1, with an inlet valve and an outlet valve;

FIG. 3 shows a four part graph for function checking of an inlet valve of an anti-lock braking system solenoid control valve according to FIG. 1 and FIG. 2 according to a first embodiment of the disclosure;

FIG. 4 shows a four part graph for function checking of an outlet valve of an anti-lock braking system solenoid control valve according to FIG. 1 and FIG. 2 according to a second embodiment of the disclosure; and,

FIG. 5 shows a four part graph for function checking of an outlet valve of an anti-lock braking system solenoid control valve according to FIG. 4 with pulsed activation.

### DETAILED DESCRIPTION

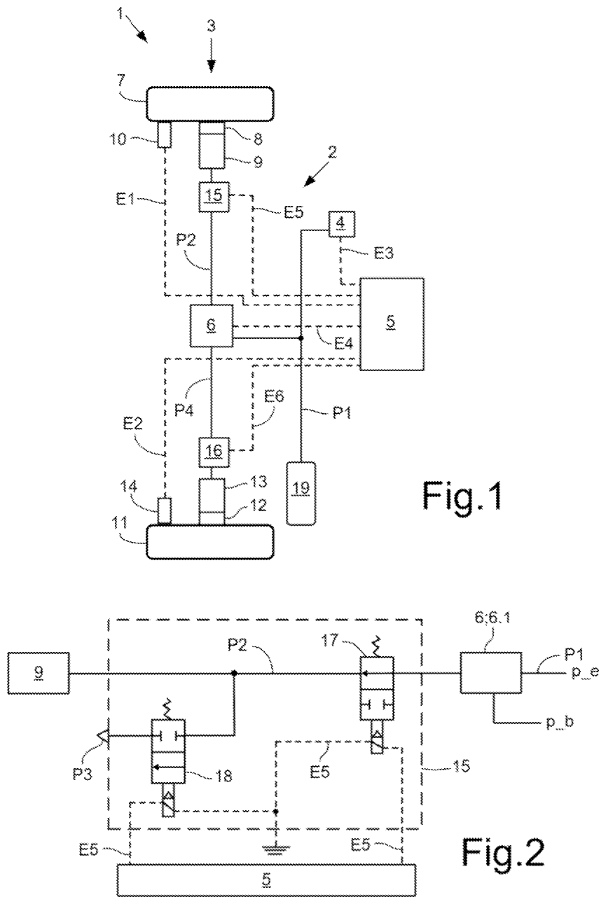

In FIG. 1, to better differentiate between electrical connections and pneumatic connections, electric lines are illustrated by an interrupted line and pneumatic lines are illustrated by a continuous line. To better distinguish between the reference numerals of the components, all reference numerals of pneumatic lines and connections are preceded by a prefix “P” and all reference numerals of electric lines are preceded by a prefix “E”.

FIG. 1 accordingly shows a schematic representation of the front axle 3 of a vehicle 1 having a pneumatically operated electronic brake system 2. The brake system 2 has a brake value generator 4, which is configured as a travel sensor. A deceleration request by the driver, which is signaled via an actuation of a brake pedal, can be detected by this brake value generator 4. The brake control signal generated by the brake value generator 4 can be relayed to a central electronic control unit 5 via an electric brake control signal line E3. The electronic control 5 unit controls and monitors the electronic brake system 2.

Moreover, a valve and sensor device 6, which is configured as an axle modulator and is simply referred to as axle modulator 6 below, is arranged on the front axle 3 of the vehicle 1 in order to apply and control a front-axle brake pressure and is electrically connected to the control unit 5 via an electric axle modulator line E4. The brake value generator 4 and the axle modulator 6 are pneumatically connected to a supply pressure accumulator 19 via a supply pressure line P1. The configuration and functionality of an axle modulator of this type and of such a brake value generator are known per se, for example from US 2020/0156601, in which a similar brake system is also described and illustrated.

A first front wheel 7, which can be braked by a first wheel brake 8, is arranged on the front axle 3. A first brake cylinder 9 and a first wheel rotation speed sensor 10, associated with the first front wheel, belong to the first wheel brake 8. Moreover, a second front wheel 11, a second wheel brake 12, a second brake cylinder 13, associated with this second wheel brake 12, and a second wheel rotation speed sensor 14, associated with the second front wheel 11, are arranged on the front axle 3. For signaling purposes, the first wheel rotation speed sensor 10 is connected to the axle modulator 6 of the front axle 3 via the electronic control unit 5 via a first electric wheel rotation speed sensor line E1 and the second wheel rotation speed sensor 14 is connected to the axle modulator 6 of the front axle 3 via the electronic control unit 5 via a second electric wheel rotation speed sensor line E2. The axle modulator 6 ascertains the wheel speeds of the front wheels 7, 11 via the two wheel rotation speed sensors 10, 14 and uses these wheel speeds to calculate any wheel slip which may be present in each case. With the aid of these values, the electronic control unit 5 controls the brake pressure for the two brake cylinders 9, 13 of the wheel brakes 8, 12 in such a way that the brake forces which can be generated are distributed to the two front wheels 7, 11 as optimally as possible.

On the rear axle (not illustrated) of the vehicle, a corresponding arrangement of vehicle wheels, wheel brakes, brake cylinders and wheel rotation speed sensors and a further axle modulator for control in conjunction with the control at the front axle 3 may be provided. This is not discussed in more detail here.

Moreover, two anti-lock braking system solenoid control valves 15, 16, abbreviated as ABS solenoid control valves 15, 16 below, are arranged on the front axle 3. These ABS solenoid control valves 15, 16 are pneumatically connected to the axle modulator 6 at the input side and to the respectively associated brake cylinder 9, 13 of the front axle 3 at the output side via a respective pneumatic solenoid control valve line P2, P4. Moreover, the ABS solenoid control valves 15, 16 are electrically connected to the electronic control unit 5 via a respective electric solenoid control valve control line E5, E6 configured as a multicore line.

FIG. 2 shows, by way of example, a simplified circuit diagram of one of the two ABS solenoid control valves 15, 16, in the present case the ABS solenoid control valve 15 for the first front wheel 7. The second ABS solenoid control valve 16 of the second front wheel 11 has an identical configuration and is therefore not illustrated separately. Accordingly, the ABS solenoid control valve 15 has an inlet valve 17 and an outlet valve 18. In a brake system 2 according to the first method variant mentioned further above, the inlet valve 17 is pneumatically connected to the axle modulator 6 at the input side and to the brake cylinder 9 of the first front wheel 7 at the output side via the first pneumatic solenoid control valve line P2. The outlet valve 18 of the ABS solenoid control valve 15 is connected to the brake cylinder 9 via the first pneumatic solenoid valve control line P2 at the input side and to a venting connection P3 at the output side. The inlet valve 17 and the outlet valve 18 are electrically connected to the electronic control unit 5, and can be activated thereby, via the multicore first electric solenoid control valve control line E5. According to the second method variant, the modified brake system (not illustrated separately in detail) does not have an axle modulator 6 but, instead, a solenoid valve 6,1 which conducts a current pneumatic brake pressure to the anti-lock braking system solenoid control valve 15, 16 in the non-actuated state and a pneumatic supply pressure to the anti-lock braking system solenoid control valve 15, 16 in the actuated state.

During normal braking of the vehicle 1, that is, when the wheels 7, 11 of the front axle 3 do not lock, the two ABS solenoid control valves 15, 16 are opened and conduct the compressed air through them to establish a desired setpoint brake pressure. If at least one front wheel 7, 11 locks, then the inlet valve 17 of the relevant ABS solenoid control valve 15, 16 closes. The ABS solenoid control valve 15, 16 for which the inlet valve 17 is closed then no longer lets further pneumatic pressure medium through to the relevant brake cylinder 9, 13. If required, pressure medium is additionally released from the brake cylinder 9, 13 via the outlet valve 18 of the ABS solenoid control valve 15, 16, specifically until the at least one front wheel 7, 11 is no longer locked, as a result of which the vehicle 1 may be safely braked.

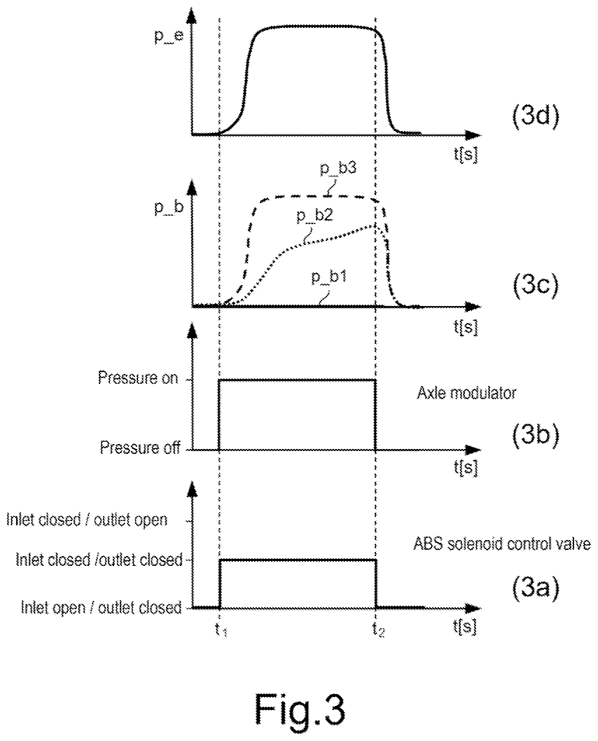

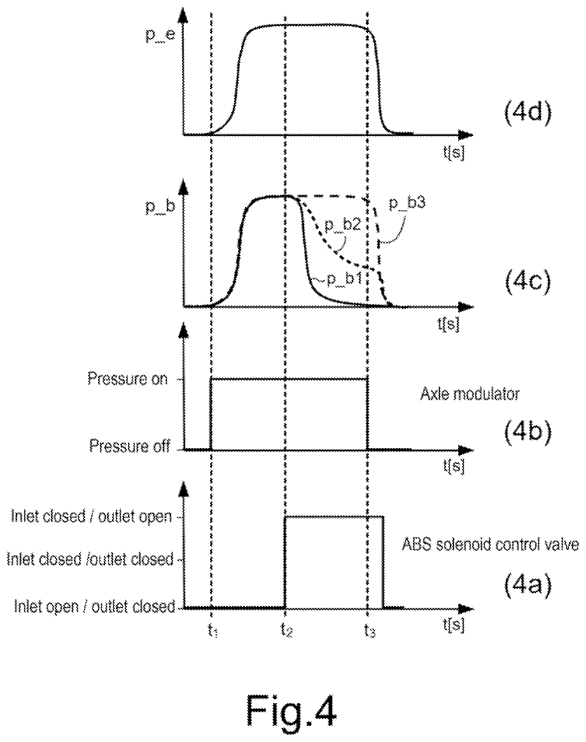

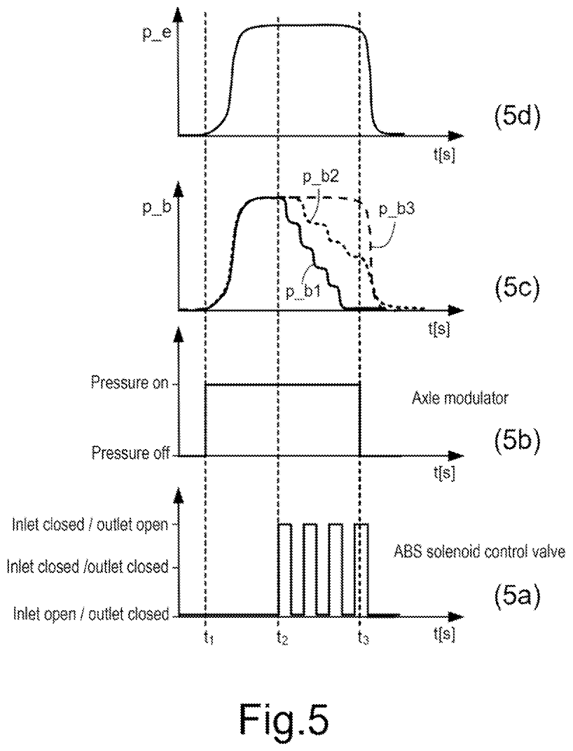

The method, presented below, having the features of the disclosure may promptly and reliably identify a malfunction at an inlet valve 17 and/or at an outlet valve 18 of an ABS solenoid control valve 15, 16 of the anti-lock braking system of the electronic brake system 2. The method is explained in more detail with the aid of the four time history graphs in FIG. 3, FIG. 4 and FIG. 5 in each case, using the front wheel 7 of the vehicle 1 as an example.

Accordingly, FIG. 3 shows the sequence of a method for function checking of the inlet valve 17 of the ABS solenoid control valve 15. The vehicle 1 here is traveling at a low speed without braking. The relevant brake cylinder 9 of the front wheel 7 is accordingly unpressurized at the start of the function check. The inlet valve 17 is initially in its non-actuated open position (inlet open) and is activated by the electronic control unit 5 to set its closed position (inlet closed) at a first time t₁ (see graph 3a). The outlet valve 18 here is in its closed position (outlet closed) in each case.

From this first time t₁, the inlet valve 17 according to graph 3b is acted upon by the supply pressure or by an input pressure p_e via the axle modulator 6 (pressure on) and remains in its closed position up to a second time t 2 (inlet closed). The pressure increase and the further pressure curve of the input pressure p_e are illustrated in graph 3d.

The functional reliability of the inlet valve 17 may now be checked at the brake pressure curve p_b (t) in the relevant brake cylinder 9, as shown in graph 3c. If the inlet valve 17 closes completely and also remains tightly closed over the further time, then actuating pressure does not build up in the brake cylinder 9, as may be read from the first curve p_b1=0. If the inlet valve 17 only closes incompletely, then a brake pressure p_b builds up gradually in the brake cylinder 9, as may be read from the second curve p_b2 (t). If the inlet valve 17 does not close at all and then also remains completely open, a comparatively high brake pressure p_b builds up spontaneously in the brake cylinder 9, as may be read from the third curve p_b3 (t). At a second time t₂, the function check according to FIG. 3 is ended (pressure off) and the actuating pressure p_3 on the input side is decreased again.

The functional reliability of the inlet valve 17 may be inferred from the behavior of the vehicle 1. If the inlet valve 17 is fully functional, the vehicle continues without braking. If the inlet valve is not functional, the relevant front wheel 7 responds with spontaneous heavy braking and possibly locks. If the inlet valve 17 is partially functional, the relevant front wheel 7 responds with gentle and increasingly heavy braking. The driver may therefore identify a malfunctioning ABS solenoid control valve 15 directly during the function check. With the aid of automatic wheel slip monitoring, the malfunction may be detected and signaled more accurately.

In graphs 4a to 4d, FIG. 4 shows the method sequence according to the disclosure for function checking of the outlet valve 18 of the ABS solenoid control valve 15. The vehicle 1 is in a non-braked stationary state here. The relevant brake cylinder 9 of the front wheel 7 is accordingly unpressurized at the start of the function check. Before the first time t₁, the inlet valve 17 is in its non-actuating position and therefore open (inlet open). Before the first time t₁, the outlet valve 18 is in its closed position (inlet closed), as can be seen in graph 4a.

From the first time t₁, the inlet valve 17 is acted upon by an input pressure p_e (pressure on) via the axle modulator 6; see graph 4b and 4d. A brake pressure p_b therefore builds up in the brake cylinder 9 (graph 4c). From a second time t 2, the inlet valve 17 is activated to set its closed position (inlet closed) and the outlet valve (18) is actuated to set its aerating position (outlet open) (graph 4a). In the case of a functional outlet valve 18, it is now expected that the brake pressure which has built up in the brake cylinder 9 between the first time t₁ and the second time t 2 will decrease completely again up to a third time t 3.

The functional reliability of the outlet valve 18 may be checked at the brake pressure curve p_b (t) in the relevant brake cylinder 9, as shown in graph 4c. If the outlet valve 18 opens completely, the pressure in the brake cylinder, as expected, decreases quickly and completely up to the third time t 3, as may be read from the first curve of the brake pressure p_b1. However, if the outlet valve 18 only opens incompletely, the pressure in the brake cylinder 9 decreases gradually or only incompletely up to the third time t 3, as may be read from the second curve of the brake pressure p_b2. If the outlet valve 18 does not open at all and remains completely closed despite a corresponding activation to set its venting position, the brake pressure p_b in the brake cylinder 9 does not decrease again, as shown by the third curve p_b3 in graph 4c.

The function check ends at a third time t 3. According to graph 4b, the axle modulator 6 switches the input pressure p_e off (pressure off). The driver identifies a malfunctioning outlet valve 18 in that a greater or lesser braking resistance needs to be overcome when subsequently moving off and the relevant front wheel 7 may even lock since, according to graph 4c, an actuating pressure is still present in the associated brake cylinder.

FIG. 5 shows a second embodiment of the method according to the disclosure for function checking of an outlet valve 18 of an ABS solenoid control valve 15. In this, the dynamic opening behavior and the dynamic closing behavior of the outlet valve 18 should be checked, as shown in particular in graph 5c. To vent the brake cylinder 9 after the pressure build-up shown in connection with FIG. 4, the outlet valve 18 is repeatedly activated to switch between assuming its venting position (outlet open) and assuming its closed position (outlet closed). If the outlet valve 18 opens and closes correctly, the brake pressure gradually decreases completely up to the third time t 3, at which the function check ends, as shown by the first curve p_b1 in graph 5c. If the outlet valve opens incompletely and/or closes incompletely, the brake pressure in the brake cylinder does not decrease completely up to the third time t 3. This is shown by the second curve p_b2 in graph 5c. If the outlet valve 18 is still not functioning despite the alternating activation described, the brake pressure p_b3 does not decrease again, or only decreases again after the third time t 3 at the end of the function check. This can be read from the third curve p_b3 in graph 5c.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1 Vehicle
2 Electronic brake system
3 Front axle
4 Brake value generator
5 Electronic control unit
6 Valve and sensor device, axle modulator
6.1 Solenoid valve
7 First vehicle wheel, first front wheel
8 First wheel brake
9 First brake cylinder
10 First wheel rotation speed sensor
11 Second vehicle wheel, second front wheel
12 Second wheel brake
13 Second brake cylinder
14 Second wheel rotation speed sensor
15 First anti-lock braking system solenoid control valve, ABS solenoid control valve
16 Second anti-lock braking system solenoid control valve, ABS solenoid control valve
17 Inlet valve
18 Outlet valve
19 Supply pressure accumulator
E1 First electric wheel rotation speed sensor line
E2 Second electric wheel rotation speed sensor line
E3 Electric brake control signal line
E4 Electric axle modulator line
E5 First electric solenoid control valve control line
E6 Second electric solenoid control valve control line
P1 Supply pressure line
P2 First pneumatic solenoid control valve line
P3 Venting connection
P4 Second pneumatic solenoid control valve line
p_b Brake pressure
p_b1 First brake pressure curve
p_b2 Second brake pressure curve
p_b3 Third brake pressure curve
p_3 Input pressure, supply pressure
t Time
t₁ First function-check time
t₂ Second function-check time
t₃ Third function-check time

1. A method for function checking of a pressure-medium operated electronic brake system of a vehicle, the pressure-medium operated electronic brake system having a valve and sensor device, a brake cylinder for actuating a brake of a vehicle wheel, at least one anti-lock braking system solenoid control valve associated with the brake cylinder, and an electronic control unit electrically connected to the valve and sensor device and to the at least one anti-lock braking system solenoid control valve, wherein the anti-lock braking system solenoid control valve has an inlet valve for aerating the brake cylinder and an outlet valve for venting the brake cylinder and is pneumatically connected to the valve and sensor device at an input side and to the brake cylinder at an output side, the method comprising:
for function checking, temporarily activating and pressurizing the anti-lock braking system solenoid control valve via the electronic control unit and via the valve and sensor device such that a pressure is built up at the input side of the anti-lock braking system solenoid control valve although a pressure increase in the brake cylinder is not expected, or a pressure decrease after an interim pressure increase is expected; and,
identifying a malfunction of the anti-lock braking system solenoid control valve if, contrary to expectations, a response of the vehicle due to a pressure increase in the brake cylinder or due to a lack of a pressure decrease after a pressure increase is established during said function checking.

2. A method for function checking of a pressure-medium operated electronic brake system of a vehicle, the pressure-medium operated electronic brake system having a brake cylinder for actuating a brake of a vehicle wheel, having at least one anti-lock braking system solenoid control valve associated with the brake cylinder, a solenoid valve configured to conduct a current pneumatic brake pressure to the anti-lock braking system solenoid control valve in a non-actuated state and a pneumatic supply pressure to the anti-lock braking system solenoid control valve in an actuated state, an electronic control unit electrically connected to the at least one anti-lock braking system solenoid control valve, wherein the anti-lock braking system solenoid control valve has an inlet valve for aerating the brake cylinder and an outlet valve for venting the brake cylinder and is pneumatically connected to the solenoid valve at an input side and to the brake cylinder at an output side, the method comprising:
for function checking, the anti-lock braking system solenoid control valve is temporarily activated and pressurized via the electronic control unit such that a pressure is built up at the input side of the anti-lock braking system solenoid control valve although a pressure increase in the associated brake cylinder is not expected, or a pressure decrease after an interim pressure increase is expected; and,
identifying a malfunction of the anti-lock braking system solenoid control valve if, contrary to expectations, a response of the vehicle due to a pressure increase, or due to a lack of a pressure decrease after a pressure increase, is established during this function check.

3. The method of claim 1, further comprising automatic monitoring of the vehicle response resulting from a faulty pressure build-up in the brake cylinder in that at least one of a braking torque, a yaw moment of the vehicle, a wheel slip of a relevant vehicle wheel, a spontaneous driver response as a result of the vehicle response is ascertained and evaluated and, if a malfunction of the inlet or outlet valve of the corresponding anti-lock braking system solenoid control valve is identified in this way, a warning signal is output.

4. The method of claim 1, wherein said identifying a malfunction of the anti-lock braking system solenoid control valve includes identifying a defective inlet valve of the anti-lock braking system solenoid control valve in a non-braked state of the vehicle at a driving speed below a specified driving speed limit value, and said identifying a defective inlet valve includes:
activating the inlet valve to set its closed position;
activating the outlet valve to set its closed position or maintain this closed position;
pressurizing the inlet valve; and,
inferring a malfunction of the inlet valve if, following a last step, a response of the vehicle which correlates with the function checking of the inlet valve is established.

5. The method of claim 1, wherein said identifying a malfunction of the anti-lock braking system solenoid control valve includes identifying a defective outlet valve of the anti-lock braking system solenoid control valve in a non-braked state of the vehicle when the vehicle is stationary, and said identifying a defective outlet valve includes:
activating the inlet valve to set its aerating position or maintain this aerating position in order to build up a pressure in the brake cylinder;
activating the outlet valve to set its closed position or maintain this closed position;
pressurizing the inlet valve;
activating the inlet valve to set its closed position;
activating the outlet valve to set its venting position in order to decrease the pressure which has built up in the brake cylinder completely; and,
inferring a malfunction of the outlet valve if, following the last step, a response of the vehicle which correlates with the function checking of the outlet valve is established.

6. The method of claim 5, wherein the activation of the outlet valve switches repeatedly back and forth between the venting position and the closed position.

7. The method of claim 1, wherein the function checking of one or more anti-lock braking system solenoid control valves takes place after switching on an ignition of a drive motor of the vehicle or after the vehicle moves off following the ignition of the drive motor.

8. The method of claim 1, wherein the function checking of one or more anti-lock braking system solenoid control valves takes place once in a specified cycle of ignition procedures of a drive motor, or moving-off procedures of the vehicle following ignition.

9. The method of claim 1, wherein the function checking of multiple anti-lock braking system solenoid control valves takes place at each axle.

10. The method of claim 1, wherein the valve and sensor device is an axle modulator.

11. The method of claim 2, further comprising automatic monitoring of the vehicle response resulting from a faulty pressure build-up in the brake cylinder in that at least one of a braking torque, a yaw moment of the vehicle, a wheel slip of a relevant vehicle wheel, a spontaneous driver response as a result of the vehicle response is ascertained and evaluated and, if a malfunction of the inlet or outlet valve of the corresponding anti-lock braking system solenoid control valve is identified in this way, a warning signal is output.

12. The method of claim 2, wherein said identifying a malfunction of the anti-lock braking system solenoid control valve includes identifying a defective inlet valve of the anti-lock braking system solenoid control valve in a non-braked state of the vehicle at a driving speed below a specified driving speed limit value, and said identifying a defective inlet valve includes:
activating the inlet valve to set its closed position;
activating the outlet valve to set its closed position or maintain this closed position;
pressurizing the inlet valve; and,
inferring a malfunction of the inlet valve if, following a last step, a response of the vehicle which correlates with the function checking of the inlet valve is established.

13. The method of claim 2, wherein said identifying a malfunction of the anti-lock braking system solenoid control valve includes identifying a defective outlet valve of the anti-lock braking system solenoid control valve in a non-braked state of the vehicle when the vehicle is stationary, and said identifying a defective outlet valve includes:
activating the inlet valve to set its aerating position or maintain this aerating position in order to build up a pressure in the brake cylinder;
activating the outlet valve to set its closed position or maintain this closed position;
pressurizing the inlet valve;
activating the inlet valve to set its closed position;
activating the outlet valve to set its venting position in order to decrease the pressure which has built up in the brake cylinder completely; and,
inferring a malfunction of the outlet valve if, following the last step, a response of the vehicle which correlates with the function checking of the outlet valve is established.

14. The method of claim 13, wherein the activation of the outlet valve switches repeatedly back and forth between the venting position and the closed position.

15. The method of claim 2, wherein the function checking of one or more anti-lock braking system solenoid control valves takes place after switching on an ignition of a drive motor of the vehicle or after the vehicle moves off following the ignition of the drive motor.

16. The method of claim 2, wherein the function checking of one or more anti-lock braking system solenoid control valves takes place once in a specified cycle of ignition procedures of a drive motor, or moving-off procedures of the vehicle following ignition.

17. The method of claim 2, wherein the function checking of multiple anti-lock braking system solenoid control valves takes place at each axle.

18. An electronic control unit of a pressure-medium operated electronic brake system of a vehicle, which is configured for function checking of anti-lock braking system solenoid control valves of the brake system and can be operated to carry out the method of claim 1.

19. An electronic control unit of a pressure-medium operated electronic brake system of a vehicle, which is configured for function checking of anti-lock braking system solenoid control valves of the brake system and can be operated to carry out the method of claim 2.

20. A pressure-medium operated electronic brake system of a vehicle, which can be operated by an electronic control unit for function checking of anti-lock braking system solenoid control valves of the brake system according to the method of claim 1.

21. A pressure-medium operated electronic brake system of a vehicle, which can be operated by an electronic control unit for function checking of anti-lock braking system solenoid control valves of the brake system according to the method of claim 2.

22. A vehicle having a pressure-medium operated electronic brake system, which can be operated by an electronic control unit for function checking of anti-lock braking system solenoid control valves of the brake system and can be operated to carry out the method of claim 1.

23. A vehicle having a pressure-medium operated electronic brake system, which can be operated by an electronic control unit for function checking of anti-lock braking system solenoid control valves of the brake system and can be operated to carry out the method of claim 2.

24. The vehicle of claim 22, wherein the vehicle is an SUV or a tractor/trailer vehicle combination.

25. The vehicle of claim 23, wherein the vehicle is an SUV or a tractor/trailer vehicle combination.
